(19) United States
(12) Patent Application Publication
(10) Pub. No.: US 2014/0158360 A1
(43) Pub. Date: Jun. 12, 2014

(54) DRAG REDUCING AGENTS FOR OIL- AND SYNTHETIC-BASED FLUIDS

(71) Applicant: Baker Hughes Incorporated, Houston, TX (US)

(72) Inventors: WILLIAM S. HALLIDAY, Cypress, TX (US); DENNIS C. CLAPPER, Houston, TX (US); RONALD G. BLAND, Houston, TX (US)

(73) Assignee: Baker Hughes Incorporated, Houston, TX (US)

(21) Appl. No.: 14/102,162

(22) Filed: Dec. 10, 2013

Related U.S. Application Data
(60) Provisional application No. 61/736,284, filed on Dec. 12, 2012.

(51) Int. Cl. C09K 8/28; E21B 43/25

(52) U.S. Cl. CPC C09K 8/28; E21B 43/25
USPC 166/305.1; 507/117

(57) ABSTRACT

Minimizing circulating pressure loss and/or reducing friction in drilling fluid operations to minimize equivalent circulating density (ECD) and maximize flow for borehole cleaning, tool optimization and efficient drilling may be achieved by the addition of friction improvers or drag reducers while circulating drilling fluids. Suitable drag reducers may include, but not necessarily be limited to, poly(alpha-olefins); polyisobutylene; condensation polymers of dicarboxylic acids or anhydrides, or polyols and monocarboxylic acids, addition polymers of unsaturated esters; copolymers of alpha-olefins with unsaturated esters; polystyrene acylated with long chain fatty acids; polyalkylene oxides; copolymers of alkyl acrylates with N-containing olefins; and combinations thereof.

### CROSS-REFERENCE TO RELATED APPLICATION

This application claims the benefit of U.S. Provisional Patent Application Ser. No. 61/736,284 filed Dec. 12, 2012, incorporated herein by reference in its entirety.

### TECHNICAL FIELD

The present invention relates to methods and compositions for reducing drag and friction losses in oil-based fluids and synthetic oil-based fluids, and more particularly relates, in one non-limiting embodiment, to methods and compositions for reducing drag and friction losses in oil-based fluids and synthetic oil-based fluids by the addition of drag reducing agents thereto.

### BACKGROUND

Drilling fluids used in the drilling of subterranean oil and gas wells along with other drilling fluid applications and drilling procedures are well known. In rotary drilling there are a variety of functions and characteristics that are expected of drilling fluids, also known as drilling muds, or simply “muds”.

Drilling fluids are typically classified according to their base fluid. In water-based muds, solid particles are suspended in water or brine. Oil can be emulsified in the water which is the continuous phase. Brine-based drilling fluids, of course are a water-based mud (WBM) in which the aqueous component is brine. Oil-based muds (OBM) are the opposite or inverse. Solid particles are often suspended in oil, and water or brine is emulsified in the oil and therefore the oil is the continuous phase. Oil-based muds can be either all-oil based or water-in-oil macroemulsions, which are also called invert emulsions. In oil-based mud the oil can consist of any suitable oil that may include, but is not limited to, diesel, mineral oil, esters, or olefins. OBMs as defined herein also include synthetic-based fluids or muds (SBMs) which are synthetically produced rather than refined from naturally-occurring materials. SBMs often include, but are not necessarily limited to, olefin oligomers of ethylene, esters made from vegetable fatty acids and alcohols, ethers and polyethers made from alcohols and polyalcohols, paraffinic, or aromatic hydrocarbons, alkyl benzenes, terpenes and other natural products and mixtures of these types.

When muds (including OBMs and/or SBMs (sometimes collectively referred to as non-aqueous fluids or NAFs)) are used as drilling fluids, there is pressure loss along the length of the wellbore. Drilling efficiency, flow rates and tool performance optimization may be reduced and loss circulation increased. Equivalent circulating density (ECD) may undesirably increase. ECD is the effective pressure exerted by a circulating fluid against the formation expressed as the equivalent density of a static fluid at that depth. The ECD is higher than the surface density due primarily to the pressure drop in the annulus above the point being considered.

It would be desirable if compositions and methods could be devised to minimize ECDs, reduce circulating pressure loss (as described above), reduce friction, reduce drag, maximize fluid flow, optimize tool performance and/or increase drilling efficiency.

### SUMMARY

There is provided, in one non-limiting form, a method of working on or treating a well in a subterranean formation which method involves pumping an oil/synthetic based fluid (O/SBF) using a pump into a wellbore. The oil/synthetic based fluid includes a naturally-occurring oil and/or a synthetic-based oil and at least one drag reducing agent in an amount effective to reduce the circulating pressure loss and/or friction of the oil/synthetic based fluid. The method additionally involves subjecting the O/SBF to a shearing force. The drag reducing agent does not possess an electric charge and is selected from the group consisting of poly(alpha-olefins); polyisobutylene; condensation polymers of monomers selected from the group consisting of monocarboxylic acids, dicarboxylic acids, anhydrides, polyols, and combinations thereof; addition polymers of unsaturated esters; copolymers of alpha-olefins with unsaturated esters; polystyrene acylated with long chain fatty acids; polyalkylene oxides; copolymers of alkyl acrylates with N-containing olefins; and combinations thereof.

There is additionally provided in another non-restrictive embodiment an oil/synthetic based fluid (O/SBF) that includes a naturally-occurring oil or a synthetic-based oil, at least one drag reducing agent in an amount effective to reduce drag in the oil/synthetic based fluid and one or more additives including, but not necessarily limited to, weighting agents, viscosifiers, fluid loss control agents, wetting agents, emulsifiers and the like and combinations thereof. The drag reducing agents described herein are also effective in fluids containing substantial solids such as drilled solids and weighting agents. Again, the drag reducing agent does not possess an electric charge and is selected from the group consisting of poly(alpha-olefins); polyisobutylene; condensation polymers of monomers selected from the group consisting of monocarboxylic acids, dicarboxylic acids, anhydrides, polyols, and combinations thereof; addition polymers of unsaturated esters; copolymers of alpha-olefins with unsaturated esters; polystyrene acylated with long chain fatty acids; polyalkylene oxides; copolymers of alkyl acrylates with N-containing olefins; and combinations thereof.

The drag reducing agent is different from the naturally-occurring oil or synthetic-based oil.

### DETAILED DESCRIPTION

It has been discovered that drag reducing agents (DRAs) are useful in reducing the drag or improving friction losses in oil/synthetic based fluids (O/SBFs) used to work on or treat a well. Operations benefiting from having a drag reducer in O/SBFs include, but are not necessarily limited to, drilling a well, working over a well, completing a well, servicing a well, production, and combinations thereof. Drag reducers will help minimize ECDs, maximize fluid flow, such as for borehole cleaning, optimize tool operation and improve drilling efficiency. These DRA additives to OBM, mineral oil-based mud, synthetic base oils and the like reduce resistance flow, thereby decreasing pressure losses while circulating these fluids during well operations, particularly during drilling.

Examples of suitable organic materials for the oil of such system fluids include but are not necessarily limited to olefins, olefin oligomers of ethylene, water insoluble esters (such as those made from vegetable fatty acids and alcohols), ethers and polyethers made from alcohols and polyalcohols, paraffinic or aromatic hydrocarbons, alkyl benzenes, terpenes and other natural products and mixtures of these types, water insoluble polyglycols, diesel, water insoluble Fischer-Tropsch reaction products, and other organic materials, in one non-limiting embodiment materials that are non-toxic at the concentrations used, and combinations thereof. Suitable olefins are branched and/or linear and preferably are relatively non-toxic synthetic olefins. Examples of suitable olefins include but are not necessarily limited to polyalphaolefins, linear alpha olefins, and internal olefins, typically skeletally isomerized olefins. Most preferred olefins are described in U.S. Pat. Nos. 5,605,872 and 5,851,958, incorporated herein by reference in their entirety. Preferred paraffins are described in U.S. Pat. No. 5,837,655, incorporated herein by reference in its entirety. These olefins may include olefins having from about 14 to about 30 carbon atoms, including linear alpha-olefins having at least 16 carbon atoms. The poly(alpha-olefins) are differentiated from the PAO DRAs by having relative lower molecular weights, for example, isomerized olefins having a size of about C20 or lower as the monomers. C20 is about the maximum length on the isomerized olefins currently employed as base oils.

DRAs are known additives for reducing drag in the pumping of fuel oil over long distances where reducing friction and reducing the energy necessary to pump the crude oil are very important. There are numerous patents and articles relating to using DRAs in crude oil pipelines.

Suitable DRAs include, but are not necessarily limited to, poly(alpha-olefins); polyisobutylene; condensation polymers of monomers selected from the group consisting of monocarboxylic acids, dicarboxylic acids, anhydrides, polyols, and combinations thereof; addition polymers of unsaturated esters; copolymers of alpha-olefins with unsaturated esters; polystyrene acylated with long chain fatty acids; polyalkylene oxides; copolymers of alkyl acrylates with N-containing olefins; and combinations thereof. In one non-restrictive version, the DRA may be a poly(alpha-olefin) (PAO) having a weight average molecular weight of from about 10,000,000 independently to about 20,000,000, where the word “independently” when used herein with respect to a range means that any lower threshold may be combined with any upper threshold to give a suitable alternative range. These high molecular weight (HMW) PAOs are generally straight polymers having side chains of C4-C10 connected to the —C—C— back bone, in a so-called “comb” or “brush” configuration. Suitable PAOs are those described in U.S. Pat. Nos. 4,527,581; 5,733,953; 6,126,872; 6,160,036; 6,649,670; 6,841,593; 6,894,088 and 7,939,584 incorporated herein by reference in their entirety.

The O/SBF may contain conventional additives for these modern drilling fluids including, but not necessarily limited to, solid weighting agents, lost circulation additives, filtration control additives, viscosifiers or rheology modifiers, emulsifiers, oil-wetting agents, lubricants, clays, tracers, brines, salts, alkalinity agents, acid gas scavengers, sweep materials, fluid loss control agents, and the like and combinations thereof. Suitable solid weighting agents include, but are not necessarily limited to, barite, hematite, calcium carbonate, siderite, ilmenite, heavy brines, galena, and the like and combinations thereof. Suitable lost circulation or fluid loss control additives, include, but are not necessarily limited to, lignite, asphalts, gilsonites, synthetic polymers and the like. Suitable viscosifiers include, but are not necessarily limited to, attapulgite, sepiolite, dimeric and trimeric fatty acids, imidazolines, amides, synthetic polymers, and the like and combinations thereof. Suitable clays include, but are not necessarily limited to, bentonite, hectorite, attapulgite, sepiolite, and the like and combinations thereof.

The effective amount of the drag reducing agent in the O/SBF may be between about 10 ppm independently to about 10 lbs/bbl (28.6 g/L); alternatively between about 0.1 lbs/bbl (0.29 g/L) independently to about 4 lbs/bbl (11.4 g/L).

In one non-limiting embodiment the DRA is introduced into the O/SBF as an internal oil phase dispersed in an aqueous phase dispersion. The amount of DRA in such an oil-in-water dispersion may range from about 0.05 independently to about 5 lbs/bbl (about 0.14 g/L independently to about 14.3 g/L); alternatively from about 0.5 lbs/bbl independently to about 2.5 lbs/bbl (about 1.4 g/L independently to about 7.2 g/L). The ratio of aqueous phase-to-DRA in this dispersion may range from about 80:20 independently to about 20:80. The DRA particle size of the DRA in the water phase ranges from about 1 independently to about 500 microns; alternatively, the particle size may range from about 10 independently to about 400 microns; in another non-limiting embodiment from about 20 independently to about 200 microns; and in still another non-restrictive version from about 25 to about 100 microns. In another non-limiting embodiment, the particle size ranges may range from about 50 independently to about 350 microns, alternatively from about 100 independently to about 300 microns, or even 200 independently to about 400 microns.

In the method of using the DRAs in O/SBFs, particularly in such O/SBF drilling fluids, the equivalent circulating density (ECD) is reduced as compared to an otherwise identical method absent the drag reducing agent. In one non-limiting embodiment, the amount is reduced by a tenth of a pound or more. In an alternate, non-restrictive embodiment herein, the total pressure loss of the circulating fluid is reduced as compared to an otherwise identical method absent the drag reducing agent, in addition to or alternatively to reducing the ECD.

In a different, non-restrictive version, the method herein includes subjecting the O/SBF to a shearing force, which shearing force may involve an operation selected from the group consisting of pumping the O/SBF using a pump (such as into a wellbore), running the O/SBF through a drill bit, drilling a well, working over a well, completing a well, servicing a well, producing a well (production), and combinations thereof. For increased efficiency, the drag reducing agent may be injected continuously into the O/SBF into fluid circulation at a low pressure side of one or more mud pumps. The shearing force may reduce the drag reduction of the drag reducing agent by up to 50%; alternatively up to about 40%, and in another non-limiting embodiment up to about 30%. This is because the shearing may physically break the HMW chains. This shearing force includes pumping the O/SBF through a pump into the wellbore. A certain amount of degradation of the DRA can be tolerated in the method herein—more than is desired to be tolerated in the applications where DRAs are used to aid in transporting oil through pipelines. This method is contrasted to conventional methods of pumping a crude oil or other hydrocarbon containing a DRA, where it is desirable to avoid degradation or breaking apart the DRA molecules for as long as possible. In that application, it is desirable to keep the DRA effective for as long in distance and time as possible. It is also expected that the methods and compositions described herein will have beneficial effects of pressure reduction in standpipes, mud pumps, downhole pressure tools and the like.

Other means of improving drag reduction include, but are not necessarily limited to lipophobic or oleophobic coatings on the contact surfaces of pipes and other equipment, or adding rheology modifiers to alter near wellbore or ultra low shear range viscosity without adversely affecting higher shear rate viscosity.

In the foregoing specification, the invention has been described with reference to specific embodiments thereof, and has been suggested as effective in providing effective methods and compositions for reducing the drag and friction of O/SBFs pumped downhole during various well operations including particularly drilling, but not limited to drilling. However, it will be evident that various modifications and changes may be made thereto without departing from the broader spirit or scope of the invention as set forth in the appended claims. Accordingly, the specification is to be regarded in an illustrative rather than a restrictive sense. For example, specific combinations of oil base fluid or synthetic oil base fluid, drag reducing agents, other conventional additives, and proportions thereof falling within the claimed parameters, but not specifically identified or tried in a particular composition or method to improve friction or reduce drag herein, are anticipated to be within the scope of this invention.

As used herein, and in the claims, the words “comprising” and “comprises” is to be interpreted to mean “including but not limited to”.

The present invention may suitably comprise, consist or consist essentially of the elements disclosed and may be practiced in the absence of an element not disclosed. For instance, a method of working on or treating a well in a subterranean formation may consist essentially of or consist of pumping an oil/synthetic based fluid (O/SBF) using a pump into a wellbore, where the O/SBF comprises, consists essentially of or consists of a naturally-occurring oil and/or synthetic-based oil and at least one drag reducing agent in an amount effective to reduce circulating pressure loss and/or friction of the oil/synthetic based fluid, where the method further consists essentially of or consists of subjecting the O/SBF to a shearing force; such an O/SBF may have conventional additives and components different from the at least one drag reducing agent. The drag reducing agent does not possess an appreciable electric charge and is selected from the group consisting of poly(alpha-olefins); polyisobutylene; condensation polymers of monomers selected from the group consisting of monocarboxylic acids, dicarboxylic acids, anhydrides, polyols, and combinations thereof; addition polymers of unsaturated esters; copolymers of alpha-olefins with unsaturated esters; polystyrene acylated with long chain fatty acids; polyalkylene oxides; copolymers of alkyl acrylates with N-containing olefins; and combinations thereof.

Alternatively, the O/SBF may consist essentially of or consist of a naturally-occurring oil and/or synthetic-based oil, at least one drag reducing agent in an amount effective to reduce drag in the oil/synthetic based fluid and one or more additional additive (also known as conventional additives) including, but not necessarily limited to, viscosifiers, solid weighting agents, filtration control agents, fluid loss control agents, wetting agents, emulsifiers, circulation additives, filtration control additives, rheology modifiers, oil-wetting agents, lubricants, clays, tracers, brines, salts, alkalinity agents, acid gas scavengers, sweep materials, and the like and combinations thereof. Again, the drag reducing agent does not possess an electric charge and is selected from the group consisting of poly(alpha-olefins); polyisobutylene; condensation polymers of monomers selected from the group consisting of monocarboxylic acids, dicarboxylic acids, anhydrides, polyols, and combinations thereof; addition polymers of unsaturated esters; copolymers of alpha-olefins with unsaturated esters; polystyrene acylated with long chain fatty acids; polyalkylene oxides; copolymers of alkyl acrylates with N-containing olefins; and combinations thereof.

What is claimed is:

1. A method of working on or treating a well in a subterranean formation comprising:
pumping an oil/synthetic based fluid (O/SBF) using a pump into a wellbore, where the oil/synthetic based fluid comprises:
an oil selected from the group consisting of naturally-occurring oils, synthetic-based oils and combinations thereof; and
at least one drag reducing agent in an amount effective to reduce circulating pressure loss and/or friction of the O/SBF, where the drag reducing agent does not possess an electric charge and is selected from the group consisting of:
poly(alpha-olefins);
polyisobutylene;
condensation polymers of monomers selected from the group consisting of monocarboxylic acids, dicarboxylic acids, anhydrides, polyols and combinations thereof;
addition polymers of unsaturated esters;
copolymers of alpha-olefins with unsaturated esters;
polystyrene acylated with long chain fatty acids;
polyalkylene oxides;
copolymers of alkyl acrylates with N-containing olefins; and
combinations thereof; and
subjecting the O/SBF to a shearing force.

2. The method of claim 1 where the effective amount of the drag reducing agent in the O/SBF is between about 10 ppm to about 10 lbs/bbl (28.6 g/L).

3. The method of claim 1 where the drag reducing agent is a poly(alpha-olefin) having a weight average molecular weight ranging from about 10,000,000 to about 20,000,000.

4. The method of claim 1 where the drag reducing agent is introduced into the oil or synthetic oil base fluid as an internal oil phase in an oil-in-water dispersion.

5. The method of claim 4 where the droplet size of the internal oil phase in the oil-in-water dispersion ranges from about 1 to about 500 microns.

6. The method of claim 1 where the fluid has an equivalent circulating density (ECD) and the ECD is reduced as compared to an otherwise identical method absent the drag reducing agent.

7. The method of claim 1 further comprising an operation selected from the group consisting of drilling a well, working over a well, completing a well, servicing a well, producing a well, and combinations thereof.

8. The method of claim 1 where subjecting the O/SBF to a shearing force includes an operation selected from the group consisting of pumping the O/SBF using a pump, running the O/SBF through a drill bit, and combinations thereof.

9. The method of claim 8 where the shearing force reduces the drag reduction of the drag reducing agent by 50%.

10. The method of claim 1 where the drag reducing agent is injected continuously into fluid circulation of the O/SBF at a low pressure side of a mud pump.

11. A method of working on or treating a well in a subterranean formation comprising:
pumping an oil/synthetic based fluid (O/SBF) using a pump into a wellbore, where the oil/synthetic based fluid comprises:
an oil or synthetic oil; and
about 10 ppm to about 10 lbs/bbl (28.6 g/L) of at least one poly(alpha-olefin) drag reducing agent having a weight average molecular weight ranging from about 10,000,000 to about 20,000,000, in an amount effective to reduce circulating pressure loss and/or friction in the O/SBF, where the drag reducing agent does not possess an electric charge; and
subjecting the O/SBF to a shearing force.

12. The method of claim 11 where the drag reducing agent is introduced into the oil or synthetic oil base fluid as an internal oil phase in an oil-in-water dispersion.

13. The method of claim 12 where the droplet size of the internal oil phase in the oil-in-water dispersion ranges from about 1 to about 500 microns.

14. The method of claim 11 further comprising an operation selected from the group consisting of drilling a well, working over a well, completing a well, servicing a well, producing a well, and combinations thereof.

15. An oil/synthetic based fluid (O/SBF) comprising:
an oil selected from the group consisting of naturally-occurring oils, synthetic-based oils and combinations thereof;
at least one drag reducing agent in an amount effective to reduce drag in the O/SBF, where the drag reducing agent does not possess an electric charge and is selected from the group consisting of:
poly(alpha-olefins);
polyisobutylene;
condensation polymers of monomers selected from the group consisting of monocarboxylic acids, dicarboxylic acids, anhydrides, polyols and combinations thereof;
addition polymers of unsaturated esters;
copolymers of alpha-olefins with unsaturated esters;
polystyrene acylated with long chain fatty acids;
polyalkylene oxides;
copolymers of alkyl acrylates with N-containing olefins; and
combinations thereof; and
at least one additive selected from the group consisting of weighting agents, viscosifiers, fluid loss control agents, wetting agents, emulsifiers, circulation additives, filtration control additives, rheology modifiers, oil-wetting agents, lubricants, clays, tracers, brines, salts, alkalinity agents, acid gas scavengers, sweep materials, and the like and combinations thereof.

16. The O/SBF of claim 15 where the effective amount of the drag reducing agent is between about 10 ppm to about 10 lbs/bbl (28.6 g/L).

17. The O/SBF of claim 15 where the drag reducing agent is a poly(alpha-olefin) having a weight average molecular weight ranging from about 10,000,000 to about 20,000,000.

18. The O/SBF of claim 15 where the drag reducing agent is introduced into the oil or synthetic oil base fluid as an internal oil phase in an oil-in-water dispersion.

19. The O/SBF of claim 18 where the droplet size in the of the oil phase in the oil-in-water dispersion ranges from about 1 to about 500 microns.

20. The O/SBF of claim 15 where the at least one drag reducing agent is present in the O/SBF as an internal oil phase in an oil-in-water emulsion, where the droplet size of the emulsion ranges from about 1 to about 500 microns.
